(19) United States
(12) Patent Application Publication
(10) Pub. No.: US 2006/0026333 A1
(43) Pub. Date: Feb. 2, 2006

(54) Multi-point USB connection

(75) Inventors: Ian James Parr, Basingstoke (GB); Andrew Jonathan King, Guildford (GB); Stephen Pritchard, Bournemouth (GB); Russell James Hicks, Basingstoke (GB)

Correspondence Address: KLARQUIST SPARKMAN, LLP, 121 S.W. SALMON STREET, SUITE 1600, PORTLAND, OR, 97204, US

(73) Assignee: Mentor Graphics Corporation

(21) Appl. No.: 11/090,959

(22) Filed: Mar. 25, 2005

(30) Foreign Application Priority Data
Mar. 31, 2004 (GB) GB0407316.9

(51) Int. Cl. G06F 13/20

(52) U.S. Cl. 710/313

(57) ABSTRACT

A USB host in one form comprises a plurality of endpoints and a state machine operable to queue user requests of multiple USB devices connectable to the host, host endpoints being dynamically allocated to corresponding endpoints of the USB devices. An exemplary method comprises, while a USB host is connected to multiple USB devices, allocating one or more host endpoints to corresponding endpoints on a USB device connected to the host; at least partially completing a user request between the one USB device and the USB host; re-allocating the host endpoints to corresponding endpoints of another USB device; and at least partially completing a user request between the other USB device and the host.

### CROSS REFERENCE TO RELATED APPLICATION

This application claims the priority from U.K. Application No. GB0407316.9 filed Mar. 31, 2004.

### BACKGROUND

This disclosure relates to communication between a host and one or more devices over a Universal Serial Bus (USB) connection.

USB provides a mechanism for connecting devices to computers. The devices may be printers, digital cameras, personal digital assistants (PDAs), modems, speakers, scanners, mice, joysticks, telephones, storage devices or any other device requiring communication or power from connection to a host computer.

USB connections are so-called “host-centric” in that the host requests information from devices which each have a unique address. Connection between a host and its devices is between an endpoint of the host and endpoints of the devices over so-called software “pipes”. Up to 127 devices can be connected to a host, either directly, or via USB hubs. Hubs can be chained together to make available many USB ports to devices from a single host. A traditional USB host would have a single endpoint which is used for all USB traffic.

It is possible to provide a host with a plurality of endpoints. For example, a USB device having multiple endpoints can be configured as a USB host having multiple endpoints available to it. One of these host endpoints can be used with traditional stack software in the conventional manner such that all USB traffic uses the one endpoint of the host with multiple endpoints. This situation is not ideal since it represents a redundancy in the hardware as many host endpoints are unused for USB traffic. A USB device when configured as a USB host with a single USB port could (like any conventional USB device), have a maximum of 31 endpoints in total: one control endpoint (0) and up to 15 endpoints in each direction of communication. Multiple devices can be connected to the host, each device having a pre-determined number of endpoints, the type and number of endpoints being defined by the hardware of the device and depending upon the type of device.

It is possible to have three different types of endpoints, each type of endpoint being associated with a particular manner of data communication:
bulk endpoints—these offer good data integrity but do not have guaranteed bandwidth—devices which use bulk endpoints comprise disk drives, printers and scanners;
isochronous endpoints—these have guaranteed bandwidth, but lower data integrity since there is no error correction facility—isochronous endpoints are particularly useful for streaming data between a host and a device in real time and so are much used by audio and video devices.
interrupt endpoints—these have fixed bandwidth and some level of error correction or data retry and are typically used for devices such as mice or keyboards which send very little data.

The previously mentioned control endpoint (0) is used during the enumeration process when a device is first connected to a host or upon power-up of the host and involves the host interrogating the devices connected to the USB bus and assigning each device an address. The host determines in the enumeration process from the devices: the types of endpoint defined in the hardware of the devices; and which form of data transfer the devices are to perform. The devices are typically characterised as requiring data transfer in an interrupt mode, a bulk transfer mode or an isochronous mode.

Whilst a USB device can have a maximum of 31 endpoints in total, it is more usual for the device to have only the endpoints it will need−that might only be three endpoints: a control endpoint—for enumeration purposes; and two bulk endpoints, one in each direction for transferring data in bulk transfer mode from and to the host. When the device with three endpoints is connected to a host with the maximum 31 endpoints, the enumeration process allocates the host endpoints to corresponding device endpoints of the same type. Some of the host endpoints are therefore allocated and cannot be reallocated to other device endpoints of subsequently connected devices. Since the control endpoint is only used during the enumeration process, the host control endpoint is available after the enumeration process for the connection of any new device. When multiple devices having a total number of endpoints exceeding the number of endpoints available on the host are connected, no more devices can be successfully connected to the host. This therefore sets a limit to the number of devices which can be connected to the host.

Data is transferred over the USB in control packets, the transfer of each control packet comprising a transaction. A conventional host with a single endpoint executes software which maintains a software list or “stack” of the various transactions requested by the host and purges the stack on an ongoing basis as the control packets are received by the host.

### SUMMARY

Since the conventional single endpoint host keeps a record of the transactions (and hence a record of data toggles in the bulk transfer mechanism), the volume of information being handled by the stack maintenance software is large and the burden on the host to build up the list of transactions and maintain the list of transactions is great. This is an onerous task for the software being executed by the host.

Desirably a means of USB communication is provided between a host and one or more devices which does not require the maintenance of the stack and further does not require host software to build up and maintain the stack.

### BRIEF DESCRIPTION OF THE DRAWINGS

In order that the present invention may be more readily understood, embodiments thereof will now be described, by way of example, with reference to the accompanying drawings, in which:

FIG. 1 is a schematic block diagram of a conventional host connected to plura; devices over USB connections; and

FIG. 2 is a schematic block diagram of an embodiment of a host connected to two devices via a USB hub.

### DESCRIPTION

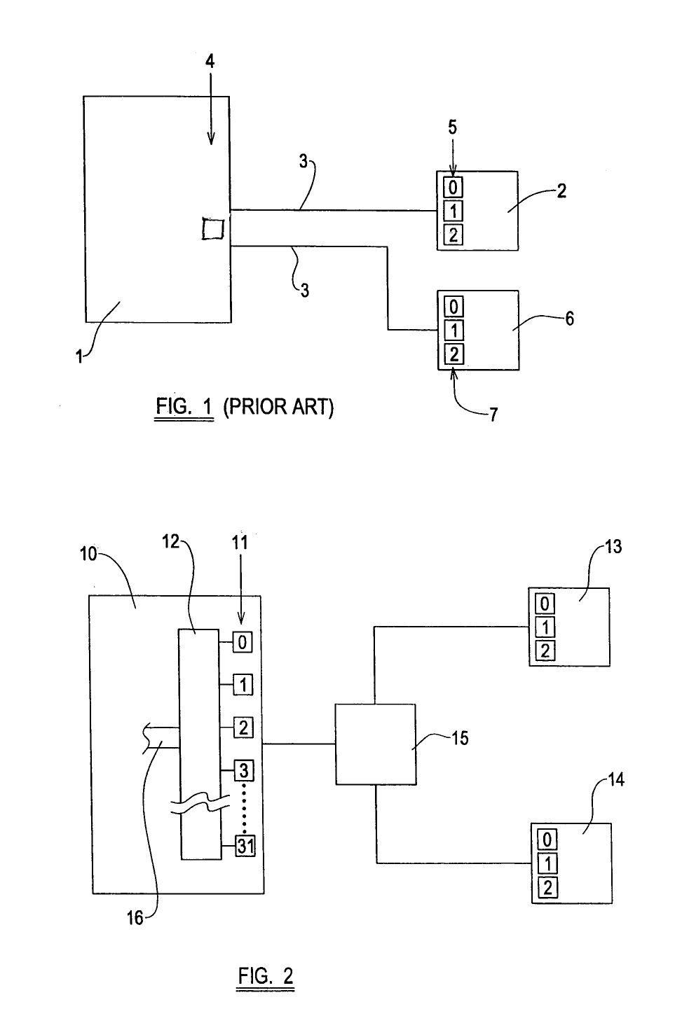

Referring to FIG. 1, in this example, a conventional USB enabled host computer 1 is connected to two USB devices 2,6 over two USB connections 3. The USB host 1 has one endpoint 4 which is used for all USB communications with the two USB devices 2,6. The first USB device 2 has three endpoints 5 which are hardware specific and defined in the device. The three device endpoints 5 comprise a control endpoint (0) and two bulk endpoints (1,2). The device control endpoint occupies the host endpoint 4 during enumeration of the device 3 by the host 1. The host endpoint 4 establishes USB communication with respective endpoints of the USB devices after enumeration and as specified and defined in the hardware of the devices 2,6. The second USB device 6 also has three endpoints 7, namely, a control endpoint (0) and two bulk endpoints (1,2).

USB communication is thence effected and the stack maintained, controlling data transfer between the host 1 and the first USB device 2 over the first device endpoints (1,2) and also between the host 1 and the second USB device 6 over the second device endpoints (1,2).

If the USB host 1 is configured with multiple endpoints 4, then the stack software would still need to build and monitor the transaction list for the host endpoint in USB communication with the multiple USB devices. The allocation of the multiple host endpoints to device endpoints is not then changed. Any changes in host endpoint allocation only occur during enumeration upon power-up of the host or allocation of free host endpoints upon connection and enumeration of a new device. This represents a redundancy in the hardware provided and a reliance on the stack software.

When multiple host endpoints 4 are available, more than one device is to be connectable to the host 1. Then, there is an endpoint limit to the number of devices which can be connected to the host. This limit is reached when the total of host endpoints 4 of a particular type required by the devices exceeds the number of this type of endpoint available at the host. Once this limit is reached, then no more devices 2,6 can be connected to the host 1. This is because the endpoints available at the host 1 are each dedicated (except the control endpoint) upon enumeration, to the hardware defined endpoints of the connected devices (this arises because the USB host is, in fact, a USB device having hardware defined endpoints which are being used as host endpoints).

Turning now to FIG. 2, an exemplary embodiment of a host 10 desirably has a maximum of 31 endpoints 11. The illustrated host also incorporates a hardware state machine 12 which provides an interface between user requests made of the host 10 and the host endpoints 11. The state machine 12 effectively makes redundant the conventional host software which would maintain “the stack” of transactions effected over the USB connection. The host maintains mapping software as will be described below.

In this example, referring to FIG. 2, two USB devices 13, 14, such as disk drives, are connected to the host 10 via a USB hub 15. The mapping software is operable to identify the status and type of the host endpoints and allocate host endpoints to connected device endpoints of corresponding type (i.e. control, isochronous and bulk) so that, once allocated, data transfer over the USB connection between the host allocated endpoints and the corresponding endpoints of the devices can be effected for that data transfer and the user requests completed. Once that data transfer is complete, or once a designated part of that data transfer is complete, the mapping software is operable again to allocate host endpoints to respective device endpoints which need servicing—i.e. to devices which are subject to a user request. User requests are generated at the host and may include requests for information from connected devices (such as disk drives) or requests to send data to connected devices (such as printers). The host mapping software which indicates which endpoints of the host are being used by what devices apportions the user requests to the respective endpoints as and when the requests are received, thereby sharing the endpoints of the host with the device endpoints.

The state machine receives user requests over a data bus 16 which connects to the various software applications running on the host. The state machine 12 takes the user requests and queues them to provide the requests serially to host endpoints which are dynamically allocated by the host mapping software to respective endpoints of the connected device capable of fulfilling the request. After a request has been handled, the next request is presented by the state machine and the host endpoints required to fulfil the next request are allocated by the host mapping software to the respective endpoints of the connected device capable of fulfilling the request. Thus, the queued requests are fed by the state machine to the appropriate endpoints which are dynamically reallocated for each request so as to fulfil that request. This arrangement means that the number of endpoints of a particular type for the connected devices can exceed the number of host endpoints of that type available. Thus, the host endpoints are shared, as required, for allocation amongst the device endpoints. This allows multiple devices to be connected to a host with multiple endpoints which might otherwise only be able to support a single USB device or to connect more USB devices than could be supported by a host with multiple endpoints.

This arrangement is particularly well suited for allocating host bulk endpoints on a dynamic basis as opposed to allocating dynamically isochronous or interrupt endpoints. Isochronous mode involves isochronous endpoints being permanently allocated since data is required to be streamed continuously in real time. There is little benefit to dynamically reallocating interrupt endpoints because of the very small volume of traffic associated therewith. On the other hand, bulk endpoints, in bulk transfer mode, are ideally suited for dynamically reallocating host endpoints.

In one example, the host computer 10 is running two separate videos on Windows media player requiring data to be streamed to one media player from device 13 and data to be streamed to the other media player from device 14. The two media players are sending user requests to the state machine for streamed video data over the bus 16, perhaps in 1 Mb blocks. The first device 13 requires to occupy two bulk transfer endpoints 11 of the host and second device 14 requires to occupy two bulk transfer endpoints of the host. The host 10 would, therefore, normally need five endpoints 11 to accommodate connection to these two devices. However, the embodiment disclosed herein provides a host 10 in which the endpoints 11 of the host can be dynamically assigned to devices at any one time to thereby effectively share the endpoints 11 of the host 10 with the devices 13,14 as and when they are required. Thus, for example, host endpoints (1) and (2) can be taken by first device 13, when streaming data from the first device 13 and then re-allocated by the host mapping software to endpoints (1) and (2) of the second device 14, so as to stream data from the second device 14 to the endpoints (1) and (2) of the host 10. Thus, there is software control of host endpoint assignments during data transfer (USB communication) with endpoints being switched at the host to communicate with endpoints of a device at designated times.

Hosts can have less than 31 endpoints. If the host shown in FIG. 2 had only three endpoints: one control endpoint (0) and two bulk endpoints (1,2), then it would not have the capacity (i.e. the number of bulk transfer endpoints) to accommodate USB connection to the two devices shown in FIG. 2 by conventional means—these two devices 13,14 require in total four host bulk transfer endpoints, whereas only two bulk transfer endpoints are available at this host. However, embodiments such as shown in FIG. 2 allow the bulk transfer endpoints at the host 10 to be reassigned, and more particularly, assigned dynamically, so that both devices 13,14 can be validly connected to the host and stream their data to the host.

It should be noted that, in FIG. 2, the hub 15 will also occupy one of the host endpoints, since the hub itself also has endpoints.

In desirable embodiments, the requested sequences of data cannot be requested in parallel of the USB devices since the requests are queued serially to the connected USB devices. As previously mentioned, the requests are queued by the state machine and proffered to the host endpoints which route the request to the respective device connected to the host in accordance with host mapping software. The requests are dealt with by the state machine as received, but in the case of large amounts of data transfer being requested at one time from or to different devices, the host software desirably interleaves the queued requests so that the multiple requests are serviced substantially contemporaneously, rather than one request needing to be completed before the next request can be fulfilled. The interleaving feature performed by the host software provides a solution to the minor difficulty of large user requests. To give an example of the interleaving solution, where user requests are received for two 1 Mb data transfers from each of two devices, each 1 Mb request would be divided into ten 100 Kb requests and these interlaced by the host software so that the state machine sends the user request in 100 Kb chunks from alternating ones of devices 1 and 2 to the host. It is possible to set a maximum data transfer size at less than 100 Kb, say 10 Kb, so that no user request can exceed a predetermined data transfer limit of, say, 10 Kb—in this way, no one user request will “hog” the allocation of host endpoints. In this regard, there may be a slight performance drop in the streaming of data since all requests are being handled serially.

Desirable benefits include dispensing with the large processing overhead of building and maintaining the stack and allowing multiple USB devices to be successfully connected to a host even if the number or type of endpoint required by the devices exceeds the number and type of endpoints available on the host. Additional benefits arise from the dynamic allocation of the multiple host endpoints whilst maintaining a USB connection to multiple USB devices. The large transaction list maintained in conventional USB connection uses large amounts of host memory and host processing resources. Embodiments of the present invention desirably still use host software to perform the endpoint mapping function and any dividing or interleaving of user requests (as required) but this uses far less memory and processing resources of the host whilst providing similar performance to a conventional USB connection.

Having illustrated and described the principles of our invention with reference to illustrated embodiments, it should be noted that the invention is not limited to such embodiments. Variations from the embodiments disclosed herein, such as in the maximum number of host endpoints if technology changes, are nevertheless within the scope of this disclosure. Also, all benefits of the illustrated embodiments, although desirable, are not required to be accomplished. The invention is directed toward all novel and non-obvious method acts and features disclosed herein, both alone and in combinations and subcombinations with one another. We claim as our invention, all such variations that fall with the spirit and scope of the following claims.

1. A USB host comprising a plurality of host endpoints and a state machine operable to queue user requests of multiple USB devices connectable to the host endpoints, the USB devices comprising device endpoints, at least some host endpoints being dynamically allocated to corresponding device endpoints of the USB devices.

2. A host according to claim 1, wherein the user request includes a determination of the USB device to which the host endpoints are to be allocated to fulfil the user request.

3. A host according to claim 2 wherein the USB host is operable to reallocate the host endpoints to corresponding endpoints of the USB devices whilst maintaining the USB connection.

4. A host according to claim 1 wherein the USB host is operable to reallocate the host endpoints to corresponding endpoints of the USB devices whilst maintaining the USB connection.

5. A host according to claim 1 wherein the USB host endpoints include a control endpoint and a plurality of bulk transfer endpoints and wherein the device endpoints comprise bulk transfer endpoints, the bulk transfer endpoints being allocatable to corresponding device bulk transfer endpoints on a device connectable to the host by USB connection.

6. A host according to claim 2 wherein the USB host endpoints include a control endpoint and a plurality of bulk transfer endpoints and wherein the device endpoints comprise bulk transfer endpoints, the bulk transfer endpoints being allocatable to corresponding device bulk transfer endpoints on a device connectable to the host by USB connection.

7. A host according to claim 1 wherein the host endpoints of the host are allocatable and re-allocatable to corresponding device endpoints whilst the USB devices are connected to the host by a USB connection.

8. A host according to claim 2 wherein the host endpoints of the host are allocatable and re-allocatable to corresponding device endpoints whilst the USB devices are connected to the host by a USB connection.

9. A host according to claim 5 wherein the host endpoints of the host are allocatable and re-allocatable to corresponding device endpoints whilst the USB devices are connected to the host by a USB connection.

10. A host according to claim 7 wherein the re-allocatable endpoints are bulk transfer endpoints.

11. A host according to claim 1 wherein the host is connected to multiple USB devices by USB connection, each device having a plurality of hardware defined endpoints, at least some of the endpoints of the host being re-allocatable by host controlled software to endpoints of the respective devices so as to complete user requests from the host of respective devices.

12. A USB host connectable by a USB connection to one or more USB devices with device endpoints, the host comprising a plurality of host endpoints which are allocatable and re-allocatable to corresponding device endpoints while the one or more USB devices are connected to the host by a USB connection.

13. A host according to claim 12 wherein the re-allocatable endpoints are bulk transfer endpoints.

14. A host according to claim 12 wherein the host is connected to multiple USB devices by USB connection, each device having a plurality of hardware defined endpoints, at least some of the endpoints of the host being re-allocatable by host controlled software to endpoints of the respective devices so as to complete user requests from the host of respective devices.

15. A host according to claim 14 wherein the host endpoints that are re-allocatable are bulk transfer endpoints.

16. A host according to claim 14 wherein the host is connected to multiple USB devices by USB connection, each device having a plurality of hardware defined endpoints, at least some of the endpoints of the host being dynamically allocatable whilst maintaining a USB connection to multiple USB devices.

17. A host according to claim 16 wherein the host endpoints that are dynamically allocatable are bulk transfer endpoints.

18. A method of allocating endpoints of a USB host whilst connected to multiple USB devices comprising:
providing a USB host with a plurality of endpoints;
providing multiple USB devices each with a plurality of endpoints, the USB devices being connected to the USB host by USB connection;
allocating one or more host endpoints to corresponding endpoints on a first USB device connected to the host;
at least partially completing a user request between the first USB device and the USB host;
re-allocating at least some of the host endpoints to corresponding endpoints of another USB device other than said first USB device; and
at least partially completing a user request between the said another USB device and the host.

19. A method according to claim 18 wherein the re-allocating act is the act of only re-allocating bulk transfer endpoints.

20. A method of servicing user requests from a USB host having multiple endpoints connected by USB connection to multiple USB devices, the host incorporating a state machine to queue user requests for data;
queuing a user request from a device connected to the host;
allocating host endpoints to corresponding device endpoints of the device associated with the user request;
completing at least a part of the user request;
noting a subsequent user request;
allocating host endpoints to corresponding device endpoints of the device associated with the subsequent user request;
completing at least a part of the subsequent user request; and
repeating the allocating and completing steps until the user requests are completed.
